(19) United States
(12) Patent Application Publication
(10) Pub. No.: US 2009/0081960 A1
(43) Pub. Date: Mar. 26, 2009

(54) Radio Navigation Satellite System Wall-Powered Electrical Appliance Controller

(76) Inventors: Gregory C. Petrisor, Los Angeles, CA (US); Ryan A. Perdue, Venice, CA (US)

Correspondence Address: Scot A. Reader, 1320 Pearl Street, Suite 228, Boulder, CO, 80302, US

(21) Appl. No.: 12/085,229

(22) PCT Filed: Dec. 22, 2006
(86) PCT No.: PCT/US06/49150

§ 371 Date: May 20, 2008

Related U.S. Application Data
(60) Provisional application No. 60/755,141, filed on Dec. 30, 2005.

(51) Int. Cl. H04B 7/00

(52) U.S. Cl. 455/70

(57) ABSTRACT

RNSS controller having a Radio Navigation Satellite System (RNSS) receiver and adapted to exert time- and location-dependent control over at least one function of a wall-powered electrical appliance in which the RNSS controller is integrated, and methods of use thereof. Such an RNSS controller in some embodiments comprises an RNSS receiver and a signal controller adapted to generate control signals based at least in part on information received from the RNSS receiver and provide the control signals to a function controller adapted to use information in the control signals to control at least one function of the appliance.

### CROSS-REFERENCE TO RELATED APPLICATION

This application claims priority to U.S. Provisional Patent Application Ser. No. 60/755,141 entitled “Radio Navigation Satellite System Wall-Powered Electrical Appliance Automatic Timer,” filed Dec. 30, 2005, the disclosure of which is incorporated herein by reference.

### BACKGROUND OF INVENTION

The present invention relates to a controller for an electrical appliance, and more particularly to an electrical appliance controller having a Radio Navigation Satellite System (RNSS) receiver and adapted to exert time- and location-dependent control over functions of the electrical appliance based on signals received by the RNSS receiver.

It is known to install manually programmable timers in wall-powered electrical appliances for performing defined functions, for example, broadcast reception, recording, cooking, laundry and time stamps, at specified times. However, such timers often fail to keep accurate time due to, for example, power interruptions, dead backup batteries and standard and daylight savings time changes. As a result, such appliances often fail to timely perform their defined tasks. One example of such failure arises when a television set or video recorder does not operate at the programmed time set by a user. Another example of such failure occurs when the message time of an incoming message on a telephone answering machine is inaccurately time-stamped and reported. Moreover, a typical home has many wall-powered electrical appliances that keep manually programmed time (clock radio, TV, VCR, DVD player, oven, telephone answering machine, telephone, etc.). In general, each appliance has its own requirements for manually programming the time or time and date. This complicates configuration as the user must remember appliance-specific programming methods or consult multiple user manuals to properly set the time or time and date. Additionally, some wall-powered electrical appliances have a backup battery to maintain the clock state in the event of wall power failure. This further complicates maintenance and is not environmentally friendly as the user must regularly buy and replace multiple battery types. Finally, manually programmable electrical appliance timers do not have a sense of location (unless manually programmed) and thus do not automatically change their local time to compensate for standard and daylight savings time. It would therefore be desirable to completely eliminate the need for users to program timers within wall-powered electrical appliances and eliminate the need for a backup battery to maintain the time in the event of a wall power failure.

Meanwhile, it is known to use RNSS receivers, such as Global Positioning System (GPS) receivers, in conjunction with a time computation system to compute the local time for display on mobile devices. It is also known to use RNSS receivers in conjunction with a time computation system as local time servers across networks.

Tognazzini U.S. Pat. No. 6,278,660, for example, addresses a timepiece that automatically changes time as it crosses a time zone boundary. The patent discusses a system for updating mobile timepieces with the correct local time as they cross time zone boundaries utilizing a local time server that computes the local time and transmits the local time to mobile timepieces. The local time is computed by a GPS system in conjunction with a computer. The patent also describes methods and software programs for computing local time from GPS signals and time zone data.

Shirota Japanese Patent Application Publication No. 2000221287 discloses approaches for updating clocks with local time. One is to compute local time from the Coordinated Universal Time (UTC) time received from a GPS car navigation system for display in the car. Another is to connect a GPS navigation system to a local time computing equipment which computes the local time based on the GPS navigation data. The user then connects the local time computing equipment to a home electronics device through a data interface to properly set the clock in the home electronics device.

Shinagawa U.S. Patent Application Publication No. 20020012290 addresses a local time computer that returns based on GPS data the local time offset for a given date and location accounting for both standard and daylight savings time. In addition, this application describes a clock that is automatically updated in a manner similar to Tognazzini's local timepiece. The problem addressed by this application is automatic correction of the displayed time of a clock based on a location where one has moved.

Oishi et. al. Japanese Patent Application Publication No. 2003114290A relates methods for computing and displaying the local time based on a position and the UTC time wherein the position and UTC time are acquired using GPS equipment. In addition, this application describes a clock that automatically displays the local time using these methods. The problem to be solved is to automatically calculate and display the local time of a destination during an overseas trip or the like.

Automatic timers for wall-powered electrical appliances and other applications that automatically update based on time information received over a wireless link are also known. However, these timers are not known to use an RNSS receiver integral to the electrical appliance to provide on-time, all-the-time functionality for the appliance without user intervention.

### SUMMARY OF THE INVENTION

The present invention, in a basic feature, comprises an RNSS controller having an RNSS receiver, such as a GPS receiver, and adapted to exert time- and location-dependent control over functions of a wall-powered electrical appliance in which the RNSS controller is integrated, and methods thereof. When powered up, the RNSS controller computes or looks up local time and date and other local information based on time and position information received from the RNSS receiver. In the event of a power disruption, the RNSS controller automatically re-determines such information upon resumption of power. Through judicious integration of an RNSS receiver into a controller for a wall-powered electrical appliance, the need for a user to enter into the appliance time, date, and other location information is advantageously reduced or eliminated outright. The need for a backup battery to maintain the clock state of the appliance in the event of a wall power failure is also eliminated.

Such an RNSS controller for a wall-powered electrical appliance in some embodiments comprises an RNSS receiver and a signal controller adapted to generate control signals based at least in part on information received from the RNSS receiver and provide the control signals to a function controller adapted to use information in the control signals to control at least one function of the electrical appliance. The RNSS receiver may be a GPS receiver. The signal controller may compute or lookup based on information received from the RNSS receiver the information supplied in the control signals. The information provided in the control signals may include one or more of an ON/OFF command, local time including adjustments for daylight savings time, location, local astronomicol information (sunrise, sunset, sun angle, star position, moonrise, moonset, moon angle, tide, etc.), local language, local radio stations, local TV stations, local area codes and local service phone numbers (emergency, schools, taxi, fast-food, etc.). Users may be inhibited from manually adjusting or setting the time or location. For example, a digital rights management (DRM) system implementation on a home electronics digital media system may require that no manual adjustment of clock or location settings be allowed.

Due to the static disposition of the RNSS controller, logic requirements for the RNSS receiver are advantageously reduced relative to RNSS receivers for mobile applications. A main requirement of the RNSS receiver of the present invention is high sensitivity to enable indoor reception. The fact that the RNSS receiver of the present invention is not mobile enables additional degrees of freedom in terms of increasing sensitivity of the RNSS receiver. Meanwhile, several requirements important to RNSS receivers for mobile applications, including time to first fix, position accuracy and velocity accuracy, have reduced significance, which substantially decreases logic requirements for the RNSS receiver of the present invention.

These and other aspects of the invention will be better understood by reference to the following detailed description taken in conjunction with the drawings that are briefly described below.

### BRIEF DESCRIPTION OF THE DRAWINGS

FIG. 1 shows an RNSS wall-powered electrical appliance in one embodiment of the invention.

FIG. 2 is a flow diagram showing operation of an RNSS controller in one embodiment of the invention.

FIGS. 3A and 3B are flow diagrams showing operation of components of a digital media player having an RNSS controller in one embodiment of the invention.

FIGS. 4A and 4B are flow diagrams showing operation of components of an oven having an RNSS controller in another embodiment of the invention.

### DETAILED DESCRIPTION OF A PREFERRED EMBODIMENT

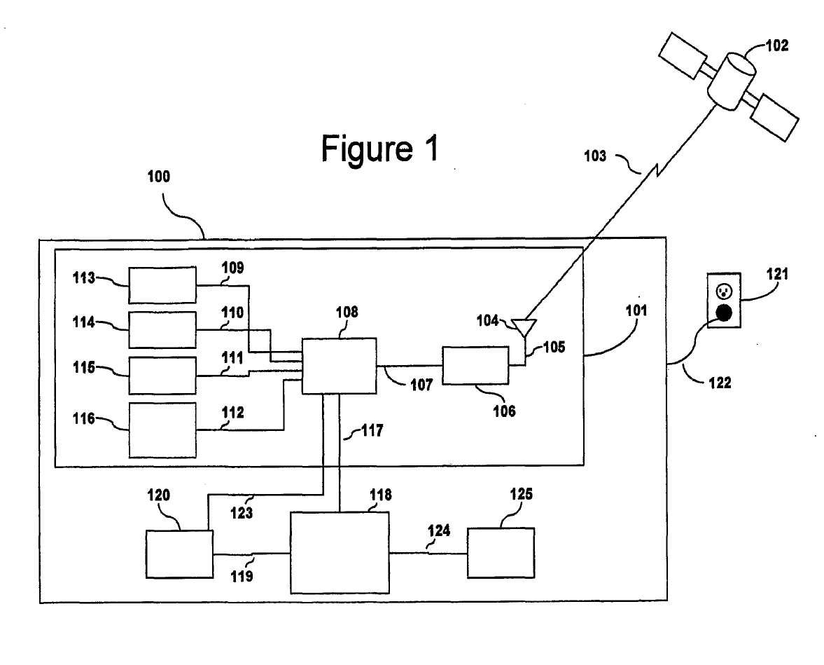

FIG. 1 shows an RNSS wall-powered electrical appliance controller 101 in one embodiment of the invention. RNSS controller 101 is integrated into a wall-powered electrical appliance 100, which may be, by way of example, a clock radio, television, VCR, DVD player, oven, microwave, coffee maker, dishwasher, water heater, telephone answering machine, telephone, washer or dryer. Appliance 100 is connected to a wall power outlet 121 with power cord 122. RNSS controller 101 contains an RNSS antenna 104 which receives signals 103 from RNSS satellites 102. RNSS antenna 104 is coupled to an RNSS receiver 106 through an antenna-coupling conductor 105. RNSS receiver 106 may be a GPS receiver, for example. RNSS controller 101 also includes a signal controller 108. Signal controller 108 receives time and position information from RNSS receiver 106 through an RNSS receiver interface 107. Signal controller 108 also in some embodiments receives inputs from an appliance user system 120 through an appliance user system interface 123. Signal controller 108 determines global time (e.g. GMT, UTC) and date from time information received from RNSS receiver 106. In some embodiments, signal controller 108 transmits the global time, date and position information to a local time system 113 through a local time system interface 109 in response to which signal controller 108 receives local time and date information from local time system 113. In some embodiments, signal controller 108 transmits the global time, date, and position information to a local sun system 114 through a sun system interface 110 and receives in response local sun position information (sunrise, sunset, current sun angle, sun intensity index, etc.). In some embodiments, signal controller 108 transmits the global time, date, and position information to a local moon system 115 through a moon system interface 111 and receives in response local moon position information (moonrise, moonset, current moon angle, moon phase, local tide, etc). In some embodiments, signal controller 108 transmits the global time and/or local time, date, and position information to a local information system 116 through a local information system interface 112 and receives in response local information (local language, local radio stations, local TV stations, local important telephone numbers, etc.). In some embodiments, signal controller 108 also receives inputs from a function controller 118 through a function controller interface 117.

Signal controller 108 generates control signals based directly or indirectly on inputs from RNSS receiver 106. Indirect use of inputs from RNSS receiver 106 includes use of responsive information received from one or more of local time system 113, sun system 114, moon system 115 and local information system 116. In some embodiments signal controller 108 also uses inputs received from function controller 118 and appliance user system 120 in producing control signals. Signal controller 108 transmits control signals to function controller 118 through the function controller interface 117. Function controller 118, using information in control signals, controls at least one function of appliance 100. Control of the function may be immediate or delayed. For example, control signals may immediately cause function controller 118 to turn on or off appliance 100. Or control signals may set a clock on appliance 100 to a current local time or set a position setting on appliance 100 to a current position, which clock or position setting is subsequently used by function controller 118 to regulate access to content. Or the control signals may set a clock on appliance 100 to a local time or set a language setting on appliance 100 to a local language, which clock or language setting is subsequently used by function controller 118 to display a clock or select language-specific information for display on appliance 100. In some embodiments, function controller 118 transmits display information to an appliance display system 125 through an appliance display system interface 124.

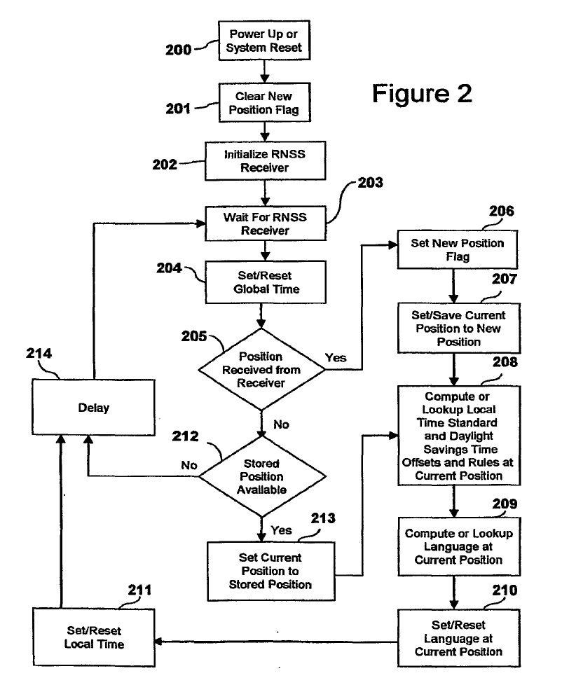

FIG. 2 shows operation of an RNSS controller integrated in appliance 100. The flow diagram description begins when appliance 100 is powered up or receives a system reset signal (200). This leads to signal controller 108 clearing a new position flag (201) and initializing RNSS receiver 106 for operation (202). Signal controller 108 then waits for RNSS receiver 106 to return information from which the global time (e.g. GMT, UTC) is computed (203). The global time is used to reset a global time clock on signal controller 108 (204). Signal controller 108 determines whether RNSS receiver 106 has also returned position information (205). In this regard, information from which global time is computed is often returned faster than position information such that the former information may be returned first. If position information is returned, signal controller 108 sets the new position flag (206), saves the new position as the stored position and sets a current position setting on function controller 118 to the new position through issuance of control signals (207). Signal controller 108 computes or looks up in a local time system the current local time offset from global time at the current position for both standard and daylight savings time (208). Signal controller 108 also computes or looks up in a local information system the local language at the current position (209). Signal controller 108 then sets the language setting on function controller 118 to the local language through issuance of control signals (210). Signal controller 108 also sets the clock on appliance 100 to the local time, which accounts for standard and daylight savings time offsets, through issuance of control signals (211). Signal controller 108 then after a delay (214) returns to Step 203. If position information was not returned, signal controller 108 determines whether the stored position from a previous RNSS receiver update is available for use (205). If so, the current position is set to the stored position (213) and the flow proceeds to Step 208. If not, signal controller 108 bypasses Steps 208-211 and after a delay (214) returns to Step 203.

It will be appreciated that the stored position and the new position flag status may be selectively applied to expedite appliance operation after power up and reset, while ensuring that appliance-specific security requirements are met. As mentioned, upon power up or reset, RNSS receiver 106 generally returns information from which time is computed faster than RNSS receiver 106 returns position information. Where security requirements do not demand real-time verification of the location of appliance 100, as in most applications, the stored position from a previous RNSS receiver update may be used to set the current language and local time on appliance 100 without waiting for RNSS receiver 106 to return new position information. On the other hand, where security requirements demand real-time verification of the applionce's location, as in some digital rights management applications, appliance 100 may by reference to the new position flag state disable use of the stored position until RNSS receiver 106 has returned fresh position information after power up or reset.

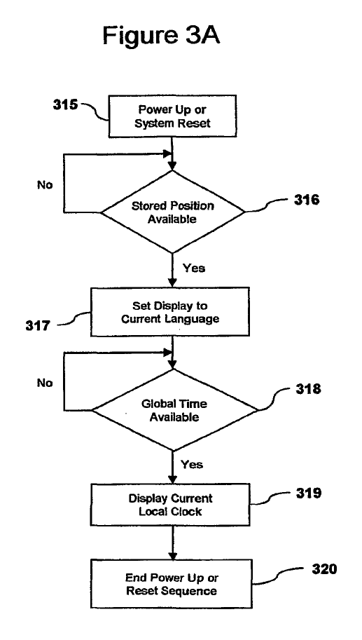

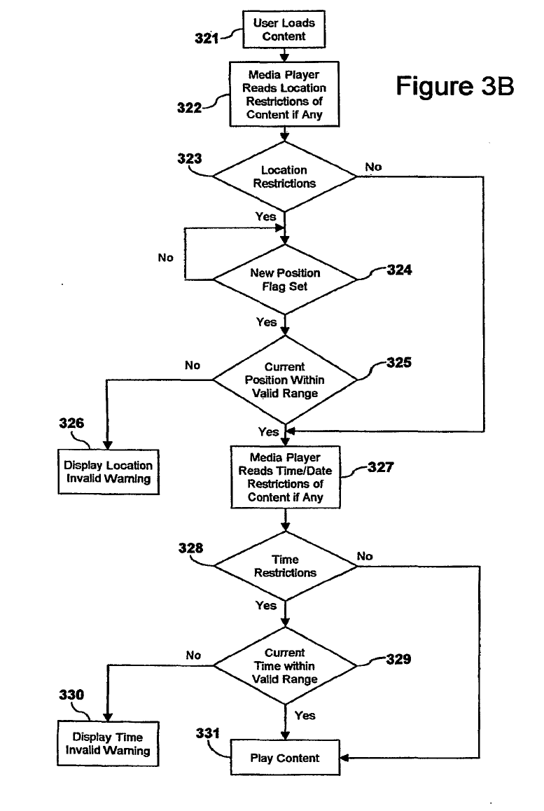

FIGS. 3A and 3B are flow diagrams showing operation of components of a digital media player having an RNSS controller in one embodiment of the invention. Turning first to FIG. 3A, operation of a function controller of the digital media player on power up or system reset is shown. The flow diagram description begins when the digital media player is powered up or receives a system reset signal (315). The function controller then waits until the stored position is available for use (316). When it becomes available, the function controller sets the display language to the current language (317). The function controller then waits until global time is available (318). When it becomes available, the function controller begins displaying the current local time (319). The function controller then ends the power up/system reset sequence (320).

FIG. 3B shows run-time operation of the function controller of the digital media player. This flow diagram begins when the user loads digital content to be played (321). The function controller first checks for and then reads any location restrictions that are embedded in the digital content (322-23). If there are no location restrictions, the flow proceeds to Step 327. If there are location restrictions, the function controller waits until the new position flog is set (324). Once the new position flag is set, the function controller checks the current position as set by the signal controller to see if the content can be played at the current location (325). If the content cannot be played at the current location the function controller displays a warning (326) to the user to notify him or her of the problem and then aborts without playing the content. If the user is not restricted from playing the content at the current location or if the content has no location restrictions, the function controller checks for and then reads any time based restrictions that are embedded in the digital content (327-28). If the content has no time based restrictions, the content is played without further delay (331). If the content has a time based restriction (such as a rental validity period) the function controller checks to see if the local clock time as initialized by the signal controller is within the valid time range of the content (329). If it is outside the valid range, the function controller causes to be displayed a warning to notify the user (330) and aborts without playing the content. If the content is within the valid time range or in the event there is no time restriction the content is played (331).

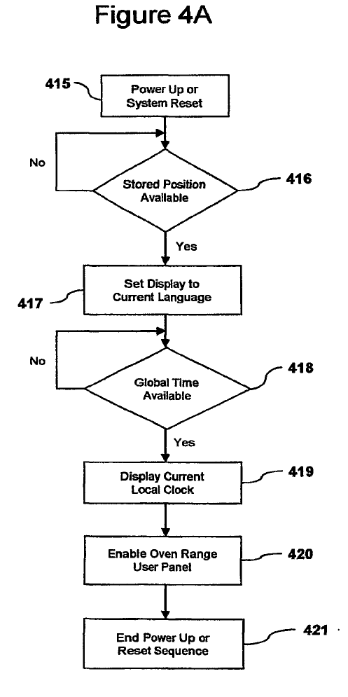

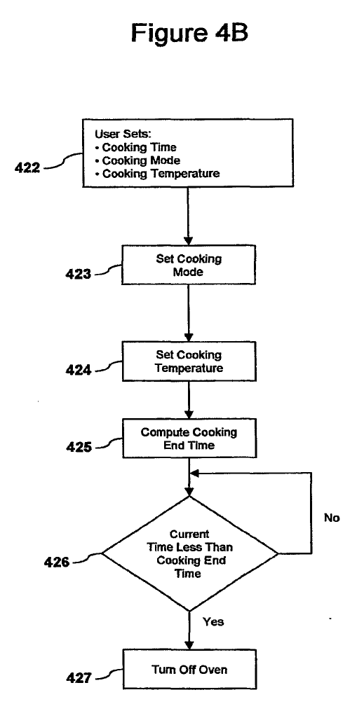

FIGS. 4A and 4B are flow diagrams showing operation of components of an oven having an RNSS controller in another embodiment of the invention. FIG. 4A shows operation of the function controller on power up of the oven. The flow diagram description begins when the oven is powered up or receives a system reset signal (415). The function controller then waits until the stored position is available for use (416). When it becomes available, the function controller sets the display language to the current language (417). The function controller then waits until global time is available (418). When it becomes available, the function controller begins displaying the current local time (419). The function controller then enables the oven user input panel (420) before ending the power up/system reset sequence (421).

FIG. 4B shows run-time operation of the oven's function controller. This flow diagram begins when the user sets the oven mode (bake, broil, etc.), the oven temperature and the cook time (422). The function controller then sets the oven cook mode (423) and the cooking temperature (424). The function controller next computes the end cook time using the current local clock initialized by the signal controller (425). The function controller next enters a loop (426) until the current time is equal or greater than the computed end cook time. The function controller next turns the oven off (427).

The RNSS receivers, signal controllers, local time system, sun system, moon system, local information system and function controllers described herein may be implemented in custom logic, such as ASICs, general purpose logic, such as software programs implemented by general purpose processors, or a combination thereof.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come within the meaning and range of equivalents thereof are intended to be embraced therein.

What is claimed is:

1. A wall-powered electrical appliance, comprising:
an RNSS receiver;
a signal controller adapted to generate control signals based at least in part on information received from the RNSS receiver; and
a function controller adapted to control at least one function of the appliance based at least in part on information received from the signal controller in the control signals.

2. The appliance of claim 1, wherein the signal controller sets a setting on the appliance through transmission of the control signals and the function controller controls the at least one function based at least in part on the setting.

3. The appliance of claim 1, wherein the function comprises a clock display.

4. The appliance of claim 1, wherein the function comprises a language display.

5. The appliance of claim 1, wherein the function comprises content access.

6. The appliance of claim 1, wherein the information received from the signal controller in the control signals comprises local time information.

7. The appliance of claim 1, wherein the information received from the signal controller in the control signals comprises position information.

8. The appliance of claim 1, wherein the information received from the signal controller in the control signals comprises local language information.

9. The appliance of claim 1, wherein the information received from the signal controller in the control signals comprises local astronomical information.

10. The appliance of claim 1, wherein the information received from the signal controller in the control signals comprises one or more of local radio stations, local TV stations, local area codes and local service phone numbers.

11. The appliance of claim 1, wherein the information received from the signal controller in the control signals comprises one or more of an on command and an off command.

12. The appliance of claim 1, wherein the information received from the RNSS receiver comprises time information received after a power up and the signal controller is adapted to generate the control signals based on the time information and position information received from the RNSS receiver and stored on the appliance before the power up.

13. A method for controlling functions of a wall-powered electrical appliance having an RNSS controller, comprising the steps of:
receiving information by the RNSS controller; and
controlling at least one function of the appliance based at least in part on information received by the RNSS controller.

14. The method of claim 13, further comprising the step of determining local information based at least in part on information received by the RNSS controller.

15. The method of claim 14, further comprising the step of generating control signals based at least in part on information received by the RNSS controller.

16. The method of claim 15, further comprising the step of setting an appliance setting based at least in part on information received by the RNSS controller.

17. The method of claim 13, wherein the appliance is selected from the group consisting of a clock radio, television, VCR, DVD player, oven, microwave, coffee maker, dishwasher, water heater, telephone answering machine, telephone, washer and dryer.

18. An RNSS controller, comprising:
an RNSS receiver; and
a signal controller adapted to generate based at least in part on information received from the RNSS receiver control signals having information adapted for use in controlling at least one function of a wall-powered electrical appliance, wherein the RNSS controller is integral to the appliance.

19. The RNSS controller of claim 18, wherein the signal controller is further adapted to set a setting on the appliance through transmission of the control signals and wherein the setting is adapted for use in controlling the at least one function of the appliance.

20. The controller of claim 18, wherein the appliance is selected from the group consisting of a clock radio, television, VCR, DVD player, oven, microwave, coffee maker, dishwasher, water heater, telephone answering machine, telephone, washer and dryer.
